(19) United States
(12) Patent Application Publication
(10) Pub. No.: US 2007/0273791 A1
(43) Pub. Date: Nov. 29, 2007

(54) Harmonic Eleimatin Of Black, Non-Activated Areas In Video Display Devices

(75) Inventor: Gijsbert Lock, Workum (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,680

(22) PCT Filed: May 26, 2005
(86) PCT No.: PCT/IB05/51731

§ 371 Date: May 8, 2007

Related U.S. Application Data
(60) Provisional application No. 60/575,870, filed on Jun. 1, 2004.

(51) Int. Cl. H04N 5/44

(52) U.S. Cl. 348/561; 348/533; 348/E05.111

(57) ABSTRACT

A video display device including a display screen (30, 40) having a first aspect ratio displays a video image (32, 47) having a second aspect ratio, together with framing images (34/36, 48/49, 54/56, 68/69), either above and below or at both sides of the video image (32, 47). The pattern and/or color of the framing images (34/36, 48/49, 54/56, 68/69) may be pre-selected to match a color of a cabinet housing the display screen (30, 40), or selected by a user based on whatever the user finds to be least distracting. Alternatively, a selection circuit may select a pattern and/or color for the framing image (34/36, 48/49, 54/56, 68/69) based on color content of the video image (32,47). Moreover, the program material containing the video image (32, 47) may include a code/codes that identifies a pattern and/or color to be used for the framing images (34/36, 48/49, 54/56, 68/69).

This invention pertains to video display devices, such as video monitors and television receivers, and more particularly to a system and method of displaying a video image having an aspect ratio that is different than the aspect ratio of the video display device.

Traditionally, the vast majority of video display devices, such as video monitors and television receivers, have been constructed with a display screen having an aspect ratio of 4:3. Therefore, until the past decade, the vast majority of video program material, and in particular television program material, has also been produced in a traditional format having a 4:3 aspect ratio. However, with the advent of advanced television and high-definition television display devices, etc., recently an increasing number of video displays are being produced whose display screens have a so-called “widescreen format” with an aspect ratio of 16:9. As a result, more and more video program material is being produced also having the widescreen format with the aspect ratio of 16:9.

Accordingly, at the present, there is a large amount of video program material in the traditional format having a 4:3 aspect ratio, and also an increasing amount of video program material in the widescreen format having a 16:9 aspect ratio. Furthermore, viewers are presently receiving or otherwise displaying program material in both formats on display screens having the 4:3 aspect ratio, and on display screens having the 16:9 aspect ratio.

When video program material having the traditional format (4:3 aspect ratio) is displayed on a display screen having the “widescreen” 16:9 aspect ratio, there is a compatibility issue. Similarly, there is also a compatibility issue when video program material having the widescreen format (16:9 aspect ratio) is displayed on a screen having the traditional 4:3 aspect ratio. In the past, these compatibility issues have resulted in portions of the display screen being “left dark” to produce dark bands.

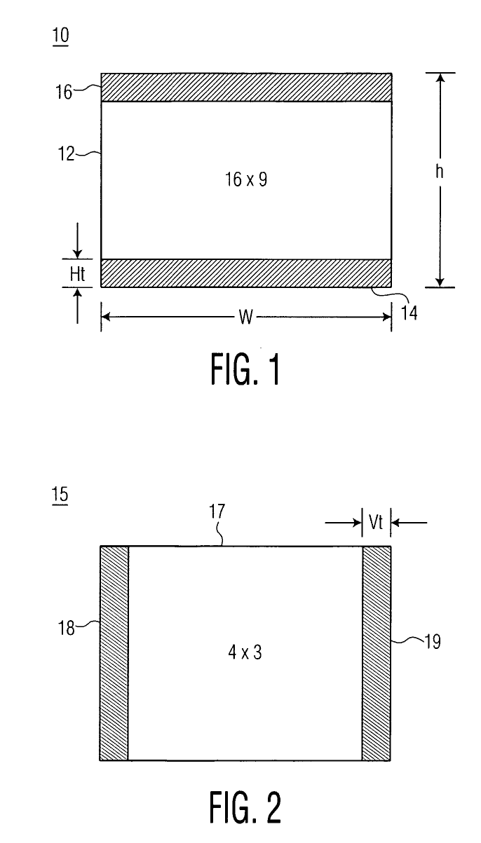

FIG. 1 illustrates a conventional method of displaying a video program having a widescreen (16:9) format on a traditional display screen 10 having a 4:3 aspect ratio. The widescreen 16:9-formatted video image 12 extends horizontally across the width of the display screen 10, but it leaves dark horizontal bands 14 and 16 at the top and bottom of the display screen 10 where no image is reproduced. The bands 14 and 16 are left at the “body color” of the display device, e.g., for a typical cathode ray tube, nearly black.

Meanwhile, FIG. 2 illustrates a conventional method of displaying a video program having a traditional 4:3 format on a widescreen-format display screen 15 having a 16:9 aspect ratio. The 4:3-formatted video image 17 extends vertically from the top to the bottom of the display screen 15, but it leaves dark vertical bands 18 and 19 at the left and right sides of the display screen 15 where no image is reproduced. Once again, the bands 18 and 19 are left at the “body color” of the display device, e.g., for a typical cathode ray tube, nearly black.

Unfortunately, these dark horizontal or vertical bands can be disturbing and unpleasant for a viewer. The dark, nearly-black color of the bands is typically not in harmonic balance with the displayed image, the bordering color of the cabinet holding the display screen, or the surrounding environment of the room where the display screen is located.

Accordingly, it would be desirable to provide a method and system for adjusting the color and/or pattern of portions of a display screen which are not being used to actively display a video image, due to an aspect ratio mismatch between the display screen and the video image.

In one aspect of the invention, a display device comprises: an input for receiving a video image; a display screen having a first aspect ratio, said display screen being adapted to display the video image at a second aspect ratio different from the first aspect ratio, together with a pair of framing images disposed either above and below or at both sides of the video image; and means for selecting one of a pattern and a color of the framing images.

In another aspect of the invention, a method of displaying a video image comprises:

receiving a video image; displaying on a display screen having a first aspect ratio the video image at a second aspect ratio different from the first aspect ratio, together with a pair of framing images disposed either above and below or at both sides of the video image; and selecting one of a pattern and a color of the framing images.

In yet another aspect of the invention, a method of displaying a video image comprises: receiving a video image; receiving at least one code; and displaying on a display screen having a first aspect ratio, the video image at a second aspect ratio different from the first aspect ratio, together with a pair of framing images disposed either above and below or at both sides of the video image, wherein at least one of a pattern and a color of the framing images corresponds to received code.

FIG. 1 illustrates a display screen having a 4:3 aspect ratio displaying a video program having a 16:9 format;

FIG. 2 illustrates a display screen having a 16:9 aspect ratio displaying a video program having a 4:3 format;

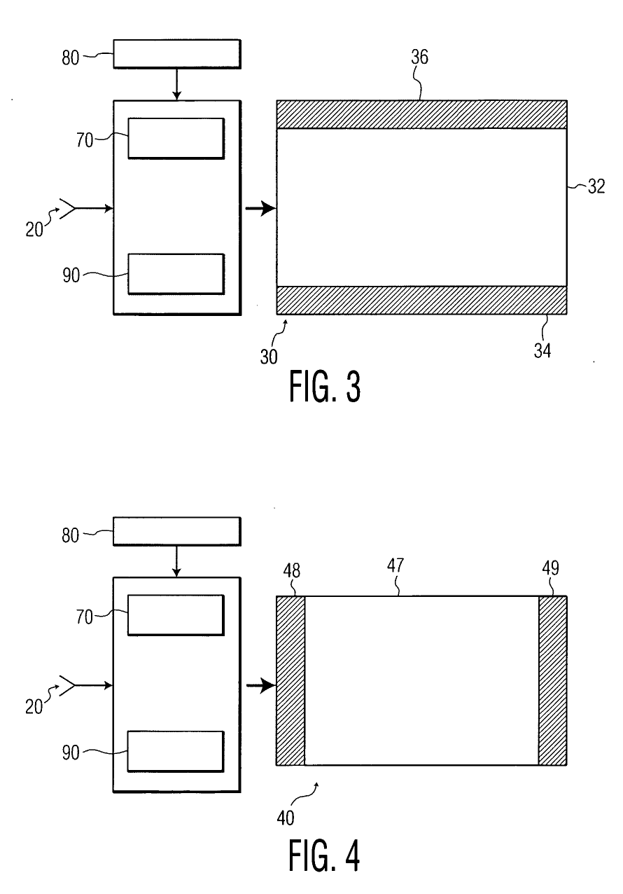

FIG. 3 illustrates a first embodiment of a display device including a display screen having a 4:3 aspect ratio displaying a video program having a 16:9 format according to one or more aspects of the present invention;

FIG. 4 illustrates a first embodiment of a display device including a display screen having a 16:9 aspect ratio displaying a video program having a 4:3 format according to one or more aspects of the present invention;

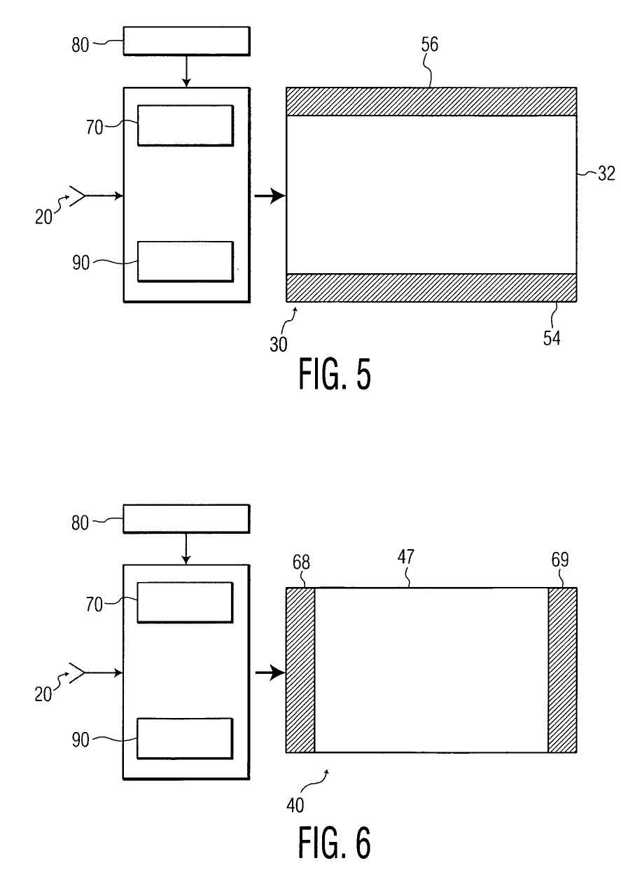

FIG. 5 illustrates a second embodiment of a display device including a display screen having a 4:3 aspect ratio displaying a video program having a 16:9 format according to one or more aspects of the present invention;

FIG. 6 illustrates a second embodiment of a display device including a display screen having a 16:9 aspect ratio displaying a video program having a 4:3 format according to one or more aspects of the present invention.

FIG. 3 illustrates a first embodiment of a display device including a video input 20 and a display screen 30 having a 4:3 aspect ratio, displaying a video program having a 16:9 format. The video image 32 has the 16:9 aspect ratio and extends horizontally across the width of the display screen 30. At the top and bottom of the display screen 30 a pair of framing images 34, 36 are displayed adjacent to the video image 32. That is, the pixels of the display screen 30 in the area of the framing images 34, 36 are actually activated and driven to display a desired color. The display screen 30 may comprise a cathode ray tube, a direct view Liquid Crystal Display (LCD) panel, a plasma display panel, an electroluminescent device, a screen of a projector (such an LCD or liquid crystal on silicon (LCOS) projector), etc. Beneficially, the framing image data is properly combined with the video image prior to being supplied to a video or data driver circuit of the display device.

In a first variation, the color of the framing images 34, 36 is prestored in a memory 70 of the display device at some point prior to delivering the display device to an end user. In that case, beneficially, the color of the framing images 34, 36 may be selected to match a color of a cabinet or housing of the display device that houses the display screen 30.

In a second variation, the color of the framing images 34, 36 is selected by a user input 80 of the display device. The user input 80 may comprise a remote control unit for the display device. In that case, a user may select a color that matches or is in harmonic balance with a background of a wall or room where the display screen 30 is located. Beneficially, a menu-driven system may be employed to provide a user with a variety of colors that can be selected by the user via her/his remote control unit. Alternatively, the remote control unit may include a variety of preset buttons for a user to select a desired color from a pre-selected palette.

In a third variation, the color of the framing images 34, 36 is automatically and dynamically adjusted based on the color content of the video image 32 by a framing image selection circuit 90. For example, if the video image 32 shows a nature scene or sporting event that contains a lot of green color, the framing images may be steered by the program material to also have a green color. A variety of techniques may be employed to process the video image 32 to produce a color for the framing images 34, 36. Beneficially, an average color point of the video image 32 may be determined - either on a frame-by-frame basis, or averaged over a number of frames - and the display device may color the pixels of the framing images 34, 36 with that color point.

In a fourth variation, source program material including the video image 32 also includes a color code identifying a color to be used for the framing images 34, 36. Such an approach is easily facilitated when the program material is a digital video signal, such as an Advanced Television (ATV) or Digital Television (DTV) signal. The color code may be selected based on the color content of the video image 32 at the time that the video program is generated, at a time when it is stored on a recordable media, etc.

FIG. 4 illustrates a first embodiment of a display device including a video input 20 and a display screen 40 having a 16:9 aspect ratio, displaying a video program having a 4:3 format according to one or more aspects of the present invention. The video image 47 has the 4:3 aspect ratio and extends vertically from the top to the bottom of the display screen 40. At the left and right sides of the display screen 40 a pair of framing images 48, 49 are displayed adjacent to the video image 47. That is, the pixels of the display screen 40 in the area of the framing images 48, 49 are actually activated and driven to display a desired color. The display screen 40 may comprise a cathode ray tube, a direct view Liquid Crystal Display (LCD) panel, a plasma display panel, an electroluminescent device, a screen of a projector, such an LCD or liquid crystal on silicon (LCOS) projector, etc.

The display device of FIG. 4 may operate with any of the four variations set forth above with respect to the display device of FIG. 3, and so for conciseness, those variations are not repeated here.

In some cases, it may be beneficial for the framing images to display a pattern instead of a uniform color. For example, it may be desirable for the framing images to exhibit a tapered color gradient profile, with the portion immediately adjacent to the video image exhibiting a color that is prevalent in the video image, and the portion which is adjacent to the edge of the display screen exhibiting a same color as the cabinet that houses the display screen.

FIG. 5 illustrates a second embodiment of a display device including a display screen 30 having a 4:3 aspect ratio displaying a video program having a 16:9 format. The video image 32 has the 16:9 aspect ratio and extends horizontally across the width of the display screen 30. At the top and bottom of the display screen 30 a pair of framing images 54, 56 are displayed adjacent to the video image 32. That is, the pixels of the display screen 30 in the area of the framing images 54, 56 are actually activated and driven to display a desired pattern having a desired color or colors.

In a first variation, the pattern and color(s) of the framing images 54, 56 are prestored in a memory 70 of the display device at some point prior to delivering the display device to an end user.

In a second variation, the pattern and color(s) of the framing images 54, 56 may be selected by a user input 80 of the display device. The user input 80 may comprise a remote control unit for the display device. In that case, a user may select a pattern and color(s) that the user finds to be least distracting or unpleasant. Beneficially, a menu-driven system may be employed to provide a user with a variety of patterns and colors that can be selected by the user via her/his remote control unit. Alternatively, the remote control unit may include a variety of preset buttons for a user to select a desired pattern and desired color(s) from a pre-selected collection.

In a third variation, the pattern and color(s) of the framing images 54, 56 is automatically and dynamically adjusted according to the color content of the video image 32 by a framing image color selection circuit 90. For example, if the video image 32 shows a nature scene or sporting event that contains a lot of green color, the framing images may be steered by the program material to tapered color gradient profile, with the portion immediately adjacent to the video image exhibiting a green color, and the portion which is adjacent to the edge of the display screen exhibiting a same color as the cabinet housing the display screen. A variety of techniques may be employed to process the video image 32 to produce a color for the framing images 54, 56. Beneficially, an average color pint of the video image may be determined - either on a frame-by-frame basis, or averaged over a number of frames - and the display device may color the pixels of the framing images 54, 36 with that color point.

In a fourth variation, source program material including the video image 32 also include a pattern code and one or more color codes identifying a pattern and color(s) to be used for the framing images 54, 56. Such an approach is easily facilitated when the program material is a digital video signal, such as an Advanced Television (ATV) or Digital Television (DTV) signal. The pattern color code(s) may be selected based on the color content of the video image 32 at the time that the video program is generated, at a time when it is stored on a recordable media, etc.

FIG. 6 illustrates a second embodiment of a display device including a display screen having a 16:9 aspect ratio displaying a video program having a 4:3 format according to one or more aspects of the present invention. The video image 47 has the 4:3 aspect ratio and extends vertically from the top to the bottom of the display screen 40. At the left and right sides of the display screen 40 a pair of framing images 68, 69 are displayed adjacent to the video image 47. That is, the pixels of the display screen 45 in the area of the framing images 68, 69 are actually activated and driven to display a desired pattern having a desired color or colors.

The display device of FIG. 6 may operate with any of the four variations set forth above with respect to the display device of FIG. 5, and so for conciseness, those variations are not repeated here.

While embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A display device, comprising:
an input (20) for receiving a video image (32, 47);
a display screen (30, 40) having a first aspect ratio, said display screen being adapted to display the video image (32, 47) at a second aspect ratio different from the first aspect ratio, together with a pair of framing images (34/36, 48/49, 54/56, 68/69) disposed either above and below, or at both sides of, the video image (32, 47); and
selection means (70, 80, 90) for selecting one of a pattern and a color of the framing images (34/36, 48/49, 54/56, 68/69).

2. The device of claim 1, wherein the selection means comprises a memory (70) for storing at least one of color data and pattern data for the framing images.

3. The device of claim 2, wherein the memory (70) stores color data corresponding to a color of a cabinet housing the display screen (30, 40).

4. The device of claim 1, wherein the selection means comprises a user input (80) for selecting at least one of color data and pattern data for the framing images (34/36, 48/49, 54/56, 68/69).

5. The device of claim 1, wherein the user input (80) comprises a remote control unit.

6. The device of claim 1, wherein the selection means comprises a framing image selection circuit (90) for selecting at least one of color data and pattern data for the framing images (34/36, 48/49, 54/56, 68/69) based on color content the video image (32, 47).

7. The device of claim 1, wherein the input (20) is adapted to receive a color code identifying one of a pattern and a color of the framing images (34/36, 48/49, 54/56, 68/69) to be displayed in conjunction with the video image (32, 47)

8. A method of displaying a video image comprises:
receiving a video image (32, 47);
displaying on a display screen (30, 40) having a first aspect ratio, the video image (32, 47) at a second aspect ratio different from the first aspect ratio, together with a pair of framing images (34/36, 48/49, 54/56, 68/69) disposed either above and below or at both sides of the video image (32, 47); and
selecting one of a pattern and a color of the framing images (34/36, 48/49, 54/56, 68/69).

9. The method of claim 8, wherein selecting one of a pattern and a color of the framing images (34/36, 48/49, 54/56, 68/69) comprises selecting a color that corresponds to a color of a cabinet housing the display screen (30, 40).

10. The method of claim 8, wherein selecting one of a pattern and a color of the framing images (34/36, 48/49, 54/56, 68/69) comprises selecting at least one of color data and pattern data for the framing images (34/36, 48/49, 54/56, 68/69) in response to a user input.

11. The method of claim 8, wherein selecting one of a pattern and a color of the framing images (34/36, 48/49, 54/56, 68/69) comprises selecting color data for the framing images (34/36, 48/49, 54/56, 68/69) based on color content the video image (32, 47).

12. The method of claim 8, further comprising storing at least one of color data and pattern data for the framing images (34/36, 48/49, 54/56, 68/69).

13. The method of claim 12, wherein the color data corresponds to a color of a cabinet housing the display screen (30, 40).

14. A method of displaying a video image comprises:
receiving a video image (32, 47);
receiving at least one code; and
displaying on a display screen (30, 40) having a first aspect ratio, the video image (32, 47) at a second aspect ratio different from the first aspect ratio, together with a pair of framing images (34/36, 48/49, 54/56, 68/69) disposed either above and below or at both sides of the video image (32, 47),
wherein at least one of a pattern and a color of the framing images (34/36, 48/49, 54/56, 68/69) corresponds to received code.

15. The method of claim 14, wherein the code is based on color content of the video image.
